(19) United States
(12) Patent Application Publication
(10) Pub. No.: US 2026/0014824 A1
(43) Pub. Date: Jan. 15, 2026

(54) BREAK-AWAY RECOVERY POINT DEVICES FOR CRASH ENERGY MANAGEMENT

(71) Applicant: Toyota Motor Engineering & Manufacturing North America, Inc., Plano, TX (US)

(72) Inventor: Robert C. DAY, Canton, MI (US)

(73) Assignees: Toyota Motor Engineering & Manufacturing North America, Inc., Plano, TX (US); Toyota Jidosha Kabushiki Kaisha, Toyota-Shi (JP)

(21) Appl. No.: 18/771,875

(22) Filed: Jul. 12, 2024

(51) Int. Cl. B60D 1/48

(52) U.S. Cl. CPC B60D 1/48

(57) ABSTRACT

A break-away recovery point device is disclosed for use with a vehicle frame. The break-away recovery point device includes a body having a recovery attachment device space, a frame attachment hole, and a break-away slot. The recovery attachment device space is configured to receive a recovery attachment device that is able to provide a supplemental pulling force. The frame attachment hole is configured to receive a first fixing element to affix the body to the vehicle frame and to enable rotation of the body about the first fixing element. The break-away slot is configured to receive a second fixing element to affix the body to the vehicle frame and to enable the body to rotate away from the second fixing element.

### BACKGROUND

Embodiments of the disclosure relate to recovery point devices that are mounted to a vehicle, and that enable recovering of the vehicle, when the vehicle is stuck in sand, mud, snow and/or cannot move without a supplemental pulling force applied by straps or cables.

### SUMMARY

An aspect of the present disclosure is drawn to a break-away recovery point device (RPD) for use with a vehicle frame. The break-away RPD includes a body having a recovery attachment device space, a frame attachment hole, and a break-away slot. The recovery attachment device space is configured to receive a recovery attachment device that is able to provide a supplemental pulling force. The frame attachment hole is configured to receive a first fixing element to affix the body to the vehicle frame and to enable rotation of the body about the first fixing element. The break-away slot is configured to receive a second fixing element to affix the body to the vehicle frame and to enable the body to rotate away from the second fixing element.

In some embodiments of this aspect, the break-away slot includes a first slot face, a second slot face, and a receiving slot end, and the receiving slot end is configured to receive the second fixing element such that the supplemental pulling force will be distributed between a first contact of the frame attachment hole with the first fixing element and the receiving slot end and the second fixing element. In some of these embodiments, the first slot face is parallel with the second slot face. In some embodiments, the first slot face is linear. In some embodiments, the first slot face is non-linear. In some of these embodiments, the first slot face includes an arc that is unaligned with a circular arc of rotation about the frame attachment hole. In some of these embodiments, the arc has a curvature that is greater than a curvature of the circular arc of rotation about the frame attachment hole. In some other of these embodiments, the arc has a curvature that is less than a curvature of the circular arc of rotation about the frame attachment hole.

In some embodiments of this aspect, the body further has a second break-away slot configured to receive a third fixing element to affix the body to the vehicle frame and to enable the body to rotate away from the third fixing element. In some of these embodiments, the second break-away slot includes a third slot face, a fourth slot face, and a second receiving slot end, and the second receiving slot end is configured to receive the third fixing element such that the supplemental pulling force will be distributed between a first contact of the frame attachment hole with the first fixing element, the receiving slot end and the second fixing element, and the second receiving slot end and the third fixing element. In some of these embodiments, the third slot face is parallel with the second slot face. In some embodiments, the third slot face is linear. In some embodiments, the third slot face is non-linear. In some of these embodiments, the third slot face includes an arc that is unaligned with a circular arc of rotation about the frame attachment hole. In some of these embodiments, the arc has a curvature that is greater than a curvature of the circular arc of rotation about the frame attachment hole. In other of these embodiments, the arc has a curvature that is less than a curvature of the circular arc of rotation about the frame attachment hole.

Another aspect of the present disclosure is drawn to a vehicle including: a vehicle frame; and a break-away RPD including a body having a recovery attachment device space, a frame attachment hole, and a break-away slot; a first fixing element; and a second fixing element. The recovery attachment device space is configured to receive a recovery attachment device that is able to provide a supplemental pulling force. The frame attachment hole is configured to receive the first fixing element to affix the body to the vehicle frame and to enable rotation of the body about the first fixing element. The break-away slot is configured to receive the second fixing element to affix the body to the vehicle frame and to enable the body to rotate away from the second fixing element

In some embodiments of this aspect, the break-away slot includes a first slot face, a second slot face, and a receiving slot end, and the receiving slot end is configured to receive the second fixing element such that the supplemental pulling force will be distributed between a first contact of the frame attachment hole with the first fixing element and the receiving slot end and the second fixing element.

Another aspect of the present disclosure is drawn to a method of mounting a break-away RPD to a vehicle frame. The method includes: inserting a first fixing element into a frame attachment hole of a body having a recovery attachment device space, the frame attachment hole, and a break-away slot to attach the body to the vehicle frame and to enable rotation of the body about the first fixing element; and inserting a second fixing element into the break-away slot further to affix the body to the vehicle frame and to enable the body to rotate away from the second fixing element, wherein the recovery attachment device space is configured to receive a recovery attachment device that is able to provide a supplemental pulling force.

In some embodiments of this aspect, the break-away slot includes a first slot face, a second slot face, and a receiving slot end, and the receiving slot end is configured to receive the second fixing element such that the supplemental pulling force will be distributed between a first contact of the frame attachment hole with the first fixing element and the receiving slot end and the second fixing element.

### BRIEF SUMMARY OF THE DRAWINGS

The accompanying drawings, which are incorporated in and form a part of the specification, illustrate example embodiments and, together with the description, serve to explain the principles of the disclosure. In the drawings:

FIG. 1A illustrates example after-market RPDs affixed to the frame of a vehicle;

FIG. 1B illustrates another example after-market RPDs affixed to the frame of a vehicle;

FIG. 2A illustrates example break-away RPDs affixed to the frame of a vehicle and in an engaged position, in accordance with aspects of the present disclosure;

FIG. 2B illustrates the break-away RPDs affixed to the frame of a vehicle of FIG. 2A with a supplemental pulling force, F_{SP}, acting on one of the break-away RPDs;

FIG. 2C illustrates the break-away RPDs affixed to the frame of a vehicle of FIG. 2A with an impact force acting on one of the break-away RPDs;

FIG. 2D illustrates the break-away RPDs affixed to the frame of a vehicle of FIG. 2A with an impact force acting on one of the break-away RPDs, and the break-away RPD breaks away;

FIG. 2E illustrates the break-away RPDs affixed to the frame of a vehicle of FIG. 2F, but after break-away RPDs partially breaks away from the frame of the vehicle;

FIG. 3A illustrates a magnified side view of the break-away RPD of FIG. 2A;

FIG. 3B illustrates the magnified side view of the break-away RPD of FIG. 3A with relative angles of slot faces;

FIG. 3C illustrates the magnified side view of the break-away RPD of FIG. 3A with rotation paths about a frame attachment hole;

FIG. 4 illustrates a front-side oblique view via of the break-away RPD of FIG. 2A;

FIG. 5A illustrates a front-side oblique view via of the break-away RPD of FIG. 2A;

FIG. 5B illustrates a rear-side oblique view via of the break-away RPD of FIG. 2A;

FIG. 5A illustrates a top-side oblique view via of the break-away RPD of FIG. 2A;

FIG. 6A illustrates a top-side oblique view via of another example break-away RPD in accordance with aspects of the present disclosure; and

FIG. 6B illustrates a side view of the break-away RPD of FIG. 6A.

### DETAILED DESCRIPTION

Some vehicles are used by drivers to “off-road.” “Off-roading” refers to the activity of driving vehicles, such as cars and trucks, on unpaved surfaces and terrain that is not suitable for regular road vehicles. The key characteristics of off-roading include: using vehicles designed for off-road use, such as 4×4s, SUVs, and off-road motorcycles, which have features like large tires, high ground clearance, and flexible suspensions to handle rough terrain; driving on surfaces like dirt roads, trails, sand, mud, rocks, and other unimproved surfaces that are not paved for regular road use; requiring specialized driving skills and techniques to navigate obstacles, maintain traction, and avoid getting stuck; providing a recreational activity for enthusiasts as well as a practical means of transportation in remote or rugged areas for activities like overlanding, camping, and land management; requiring responsible practices to minimize environmental impact, such as staying on designated trails, packing out trash, and respecting wildlife.

To rectify situations wherein a vehicle gets “stuck” while off-roading, some vehicles have RPDs incorporated into the frame of the vehicle. The incorporated RPDs enable an attachment device, such as a strap or cable, to attach to the RPD, wherein the attachment device can provide a supplemental pulling force to recover of the vehicle, when the vehicle is stuck in sand, mud, snow and/or cannot otherwise move.

However, some vehicles do not have RPDs incorporated into the frame of the vehicle. If the owner wants to off-road, the owner may purchase after-market RPDs, and mount the after-market PRDs to the frame of the vehicle. “After-market” in this respect means parts that are not made by the original vehicle manufacturer.

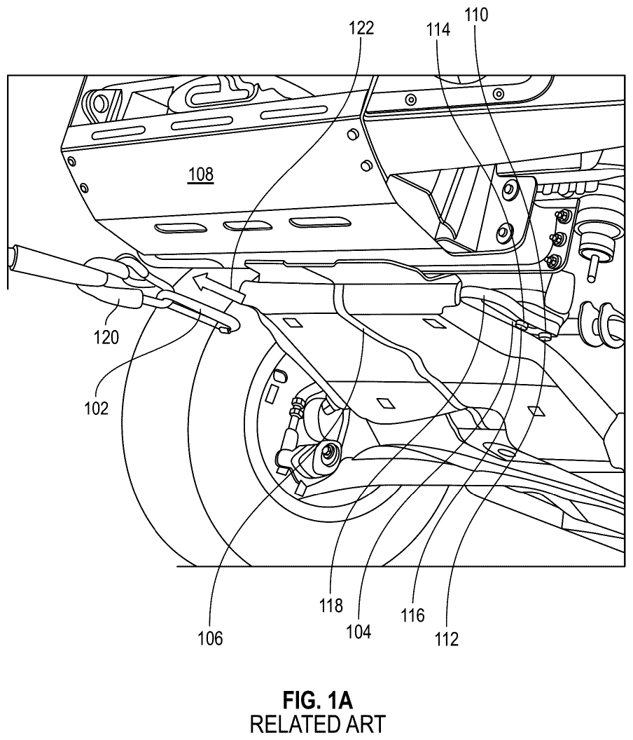

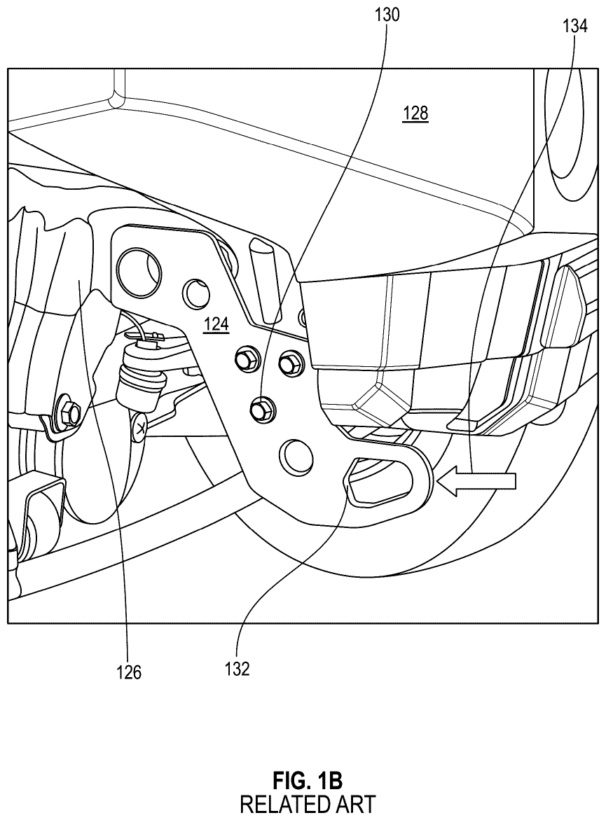

FIG. 1A illustrates example after-market RPDs 102 and 104 affixed to a frame 106 of a vehicle 108.

As shown in the figure, each of after-market RPDs 102 and 104 includes at least one respective frame attachment hole and an attachment device space. A frame attachment hole is configured to receive a fixing element to affix the after-market RPD to frame 106. An attachment device space is configured to receive a recovery attachment device that is able to provide a supplemental pulling force, F_{SP}.

For example, after-market RPD 104 includes a frame attachment hole 110 that is configured to receive a bolt 112 and a frame attachment hole 114 that is configured to receive a bolt 116 to affix after-market RPD 104 to frame 106. Further, after-market RPD 104 further includes an attachment device space 118 configured to receive a recovery attachment device that is able to provide F_{SP}.

As further shown in the figure, after-market RPD 102 has a recovery attachment device 120 that is able to provide F_{SP} 122 to frame 106.

In operation, after-market RPDs 102 are attached to vehicle 108 as shown. For purposes of discussion, suppose that the driver of vehicle 108 is off-roading and becomes stuck, for example in sand, mud, etc., and cannot move. The driver of vehicle 108, or another person, may attach one end of recovery attachment device 120 to after-market RPD 102. The other end (not shown) of recovery attachment device 120 may be attached to another vehicle (not shown), for example by a similar after-market RPD 102, a trailer hitch, or a towing winch. Moving the other vehicle, or operating the towing winch, recovery attachment device 120 applies F_{SP} 122 so as to help pull vehicle 108 from its stuck position.

FIG. 1B illustrates another example of an after-market RPD 124 affixed to a frame 126 of a vehicle 128.

As shown in the figure, after-market RPD 124 includes a plurality of frame attachment holes, a sample of which is indicated as frame attachment hole 130, and an attachment device space 132. Each frame attachment hole is configured to receive a respective fixing element to affix after-market RPD 124 to frame 126.

Current RPDs in the market, such as those discussed above with reference to FIGS. 1A-B are rigidly attached to a vehicle and do not break-away from the vehicle frame during crash event.

For example, returning to FIG. 1B, consider a situation where vehicle 128 is involved with a head-on collision, wherein an extremely high impact force 134 is applied to the front of after-market RPD 124. In such a situation, impact force 134 will travel through after-market RPD 124 and be transferred to frame 126 via the fixing elements that affix after-market RPD 124 to frame 126.

The problem with this transfer of impact force is that frame 126 is not likely designed to receive an impact force at these points or from the direction of the transfer of impact force 134. On the contrary, typically frame 126 is designed to deform in a predetermined fashion from a head-on collision so as to minimize trauma to the occupants of vehicle 128 and to minimize damage to vehicle 128. When after-market RPD 124 is attached to frame 126, and after-market RPD 124 receives impact force 134, frame 126 will deform in a fashion dissimilar to the predetermined fashion for which frame 126 was designed. Accordingly, when after-market RPD 124 is attached to frame 126, and after-market RPD 124 receives impact force 134, frame 126 will deform in a fashion from a head-on collision may increase trauma to the occupants of vehicle 128 and increase damage to vehicle 128.

What is needed is an after-market RPD that may be attached to vehicle frame, such that if the after-market RPD receives impact force, the frame will deform in the originally designed fashion from a head-on collision so as to minimize trauma to the occupants of vehicle and minimized damage to vehicle.

A break-away RPD in accordance with aspects of the present disclosure may be attached to vehicle frame, such that if the after-market RPD receives impact force, the frame will deform in the originally designed fashion from a head-on collision so as to minimize trauma to the occupants of vehicle and minimized damage to vehicle.

In particular, a break-away RPD in accordance with aspects of the present disclosure performs the function of a RPD during vehicle recovery operations, but breaks away during crash to allow for proper crush/energy absorption within vehicle frame to achieve good crash performance.

In at least one embodiment, a break-away RPD includes three attachment points to vehicle frame. Two of the three attachment points include a slot (instead of a hole). At the two locations with slots, upon receiving an impact above a pre-determined threshold, the recovery point will rotate out of the way and prevent high loads from being transferred down the frame rail. The third attachment point with a hole keeps the break-away RPD attached to the vehicle frame during crash.

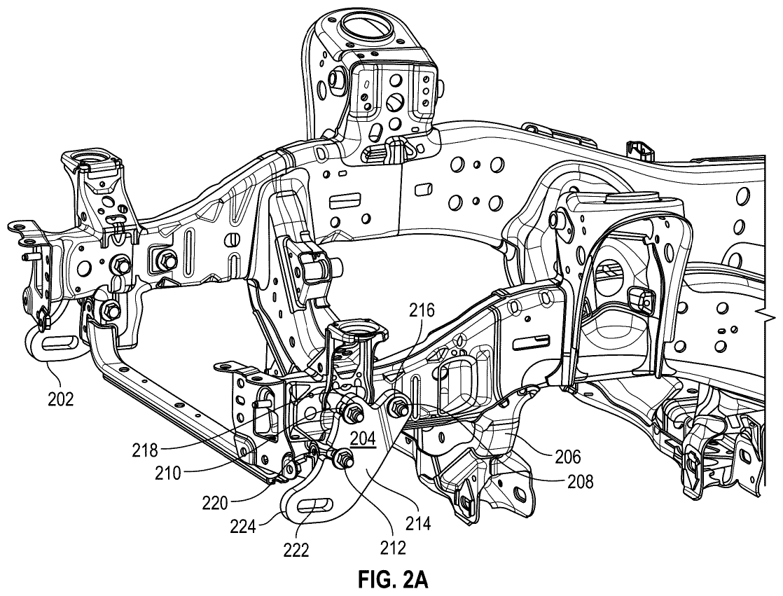

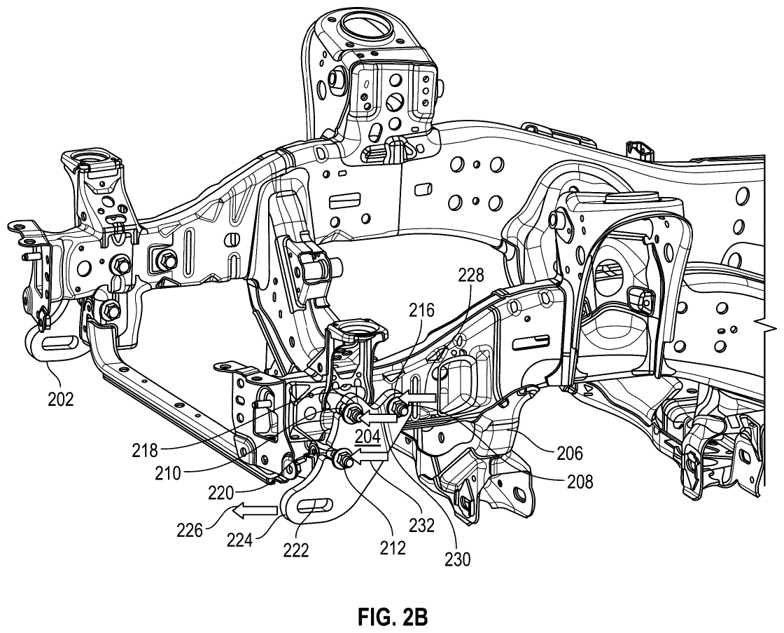

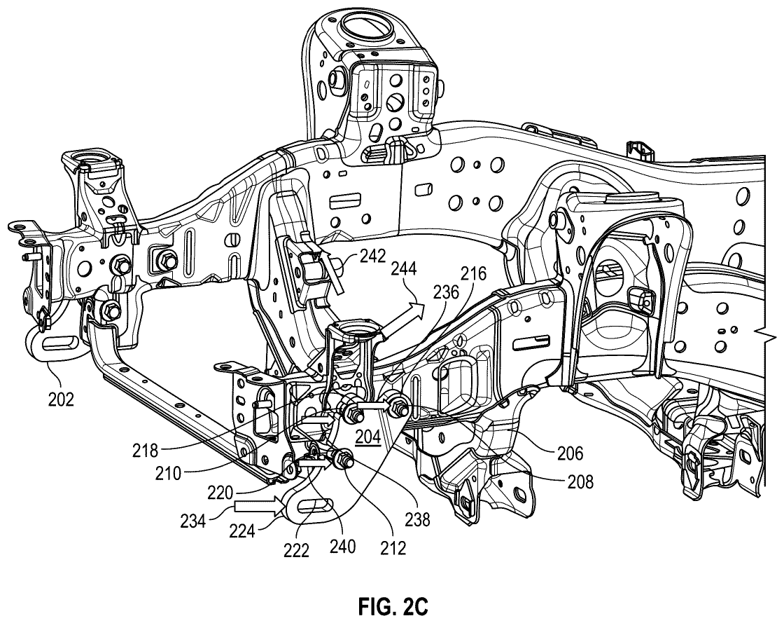

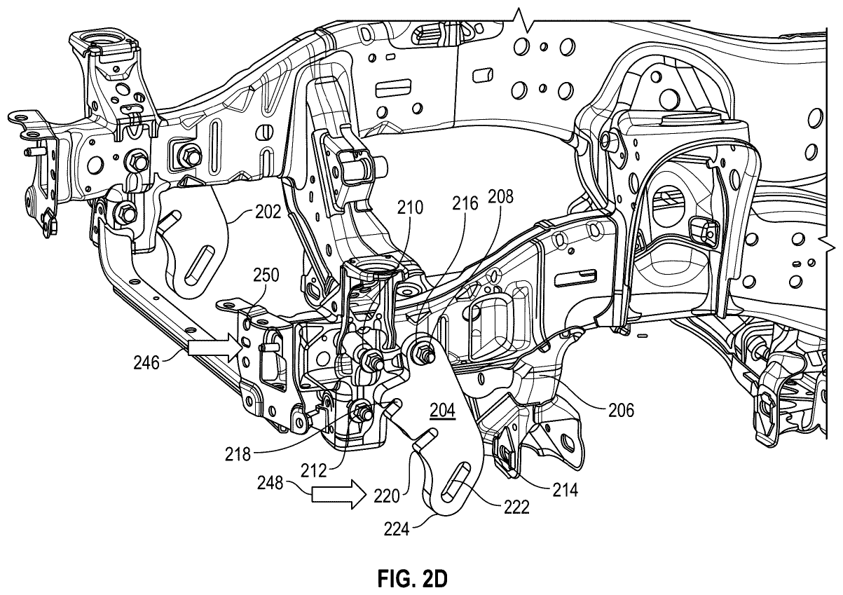

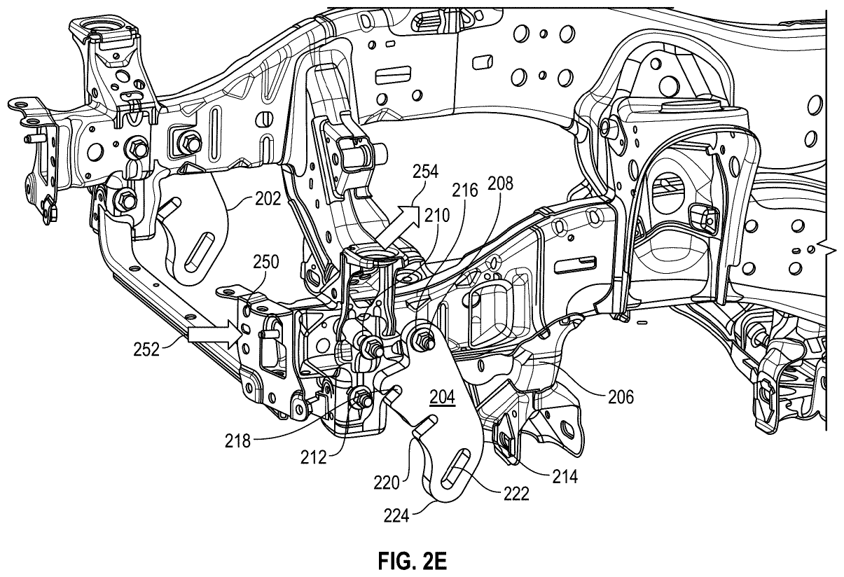

Example break-away RPDs in accordance with aspects of the present disclosure will now be described in greater detail with reference to FIGS. 2A-6B.

FIG. 2A illustrates example break-away RPDs 202 and 204 affixed to a frame 206 of a vehicle and in an engaged position, in accordance with aspects of the present disclosure.

Break-away RPD 202 has the same shape and function as break-away RPD 204. As such, for purposes of brevity, the shape and function of only break-away RPD 204 will be described in greater detail.

As shown in the figure, break-away RPD 204 includes a body 214 having a recovery attachment device space 222, a frame attachment hole 216, a break-away slot 218 and a break-away slot 220.

Recovery attachment device space 222 is configured to receive a recovery attachment device that is able to provide a supplemental pulling force. In this non-limiting example embodiment, recovery attachment device space 222 has the shape of an elongated slot with rounded ends. However, in other embodiments, recovery attachment device space 222 may have any shape that is configured to receive a recovery attachment device that is able to provide a supplemental pulling force, non-limiting example shapes of which include circular, elliptical, rectangular, etc.

Frame attachment hole 216 is configured to receive a bolt 208 to affix body 214 to frame 206 and to enable rotation of body 214 about bolt 208 in some situations, as will be described in greater detail below. It should be known that bolt 208 may be substituted by any known type of fixing element that is configured to affix body 214 to frame 206 and to enable rotation of body 214 about the fixing element, non-limiting examples of which includes screws, etc.

Break-away slot 218 is configured to receive a bolt 210 to affix body 214 to frame 206 and to enable body 214 to rotate away from bolt 210 in some situations, as will be described in greater detail below. It should be known that bolt 210 may be substituted by any known type of fixing element that is configured to affix body 214 to frame 206 and to enable rotation of body 214 away from the fixing element, non-limiting examples of which includes screws, etc.

Break-away slot 220 is configured to receive a bolt 212 to affix body 214 to frame 206 and to enable body 214 to rotate away from bolt 212 in some situations, as will be described in greater detail below. It should be known that bolt 212 may be substituted by any known type of fixing element that is configured to affix body 214 to frame 206 and to enable rotation of body 214 away from the fixing element, non-limiting examples of which includes screws, etc.

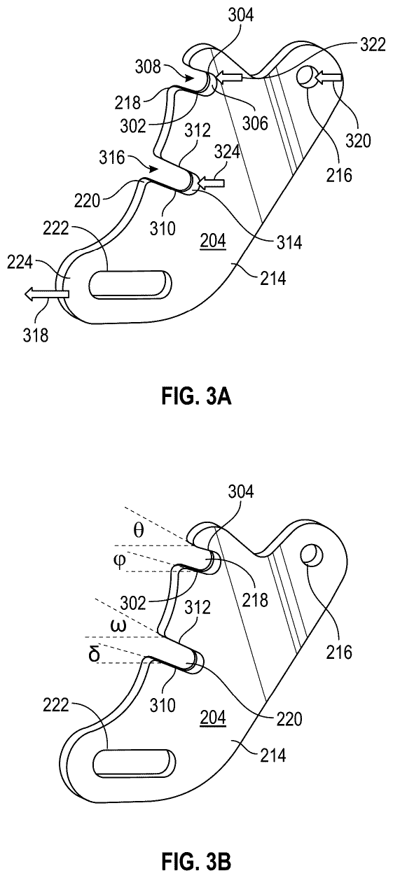

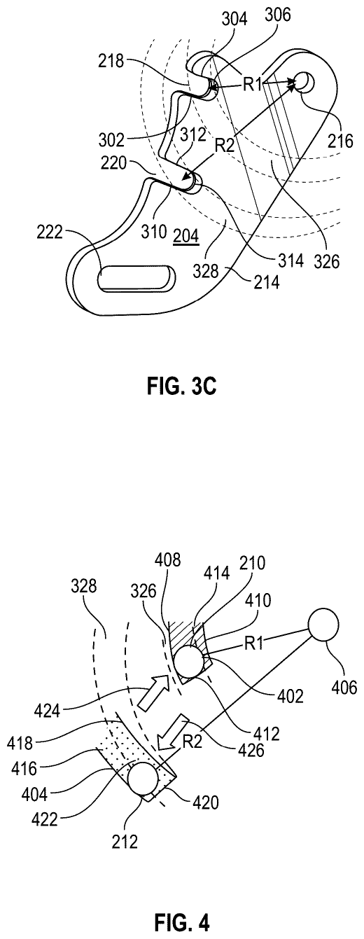

In some embodiments, at least one of frame attachment hole 216, break-away slot 218, and break-away slot 220 are configured to receive a fixing element that is different from at least one of the other of frame attachment hole 216, break-away slot 218, and break-away slot 220. A more detailed description of break-away slot 218 and break-away slot 220 will now be described in greater detail with reference to FIG. 3A.

FIG. 3A illustrates a magnified side view of break-away RPD 204.

As shown in the figure, break-away slot 218 includes a slot face 302, a slot face 304, a receiving slot end 306, and a slot opening 308. Break-away slot 220 includes a slot face 310, a slot face 312, a receiving slot end 314, and a slot opening 316.

Receiving slot end 306 is configured such that bolt 210 will rest against receiving slot end 306 when break-away RPD 204 is mounted to frame 206 in a position as discussed above with reference to FIG. 2A. Similarly, receiving slot end 314 is configured such that bolt 212 will rest against receiving slot end 314 when break-away RPD 204 is mounted to frame 206 in a position as discussed above with reference to FIG. 2A.

In operation, when mounted in a position as illustrated in FIG. 2A, when a recovery attachment device is attached to recovery attachment device space 222, and when the recovery attachment device provides F_{SP} 318, F_{SP} 318 is transferred to frame 206 (not shown) via the respective bolts within break-away slot 218, frame attachment hole 216 and break-away slot 220.

In particular, a portion 320 of F_{SP} 318 is applied to bolt 208 via the side of frame attachment hole 216, a portion 322 of F_{SP} 318 is applied to bolt 210 via receiving slot end 306 of break-away slot 218, and a portion 324 of F_{SP} 318 is applied to bolt 212 via receiving slot end 314 of break-away slot 220. This will be described in greater detail with reference to FIG. 2B.

FIG. 2B illustrates break-away RPDs 202 and 204 affixed to frame 206 with a F_{SP} 226 acting on break-away RPD 204.

As shown in the figure, when F_{SP} 226 is applied to RPD 204 by recovery attachment device (not shown), F_{SP} 226 is transferred to bolt 208 as shown but pulling force 228, to bolt 210 as shown by pulling force 230, and to bolt 212 as shown by pulling force 232. In short, the total of F_{SP} 226 is distributed between bolts 208, 210, and 212, such that F_{SP} 226 equals the sum of pulling force 228, pulling force 230, and pulling force 232. As will be known to those of skill in the art, the distribution of F_{SP} 226 between pulling force 228, pulling force 230, and pulling force 232 will be dependent upon the shape of break-away RPD 204 and the location of each of bolts 208, 210, and 212, which is outside the scope of this discussion, and will not therefore be discussed in detail.

In any event, F_{SP} 226 is transferred to bolts 208, 210, and 212, which in turn transfers a pulling force, equal to F_{SP} 226, to frame 206. F_{SP} 226 is used to pull the vehicle (not shown) from a stuck position.

It should be noted that each of break-away RPDs 202 and 204 has a single respective frame attachment hole, and two respective break-away slots.

In other embodiments in accordance with aspects of the present disclosure, a break-away RPD may include only a single break-away slot. In these embodiments, the single break-away slot would require one less bolt to attach the break-away RPD to frame 206, thereby decreasing the time required to mount the break-away RPD to frame 206. However, in these embodiments, the single break-away slot would result in a distribution of the supplemental pulling force such that the supplemental pulling force is increased at each of the single bolt resting within the single break-away slot and the bolt within a frame attachment hole.

In still other embodiments in accordance with aspects of the present disclosure, a break-away RPD may include more than two break-away slots. In these embodiments, the more than two break-away slots would require respective more than two bolts to attach the break-away RPD to frame 206, thereby increasing the time required to mount the break-away RPD to frame 206. However, in these embodiments, the more than two break-away slots would result in a distribution of the supplemental pulling force such that the supplemental pulling force is decreased at each of the more than two bolts resting within the respective more than two break-away slots and the bolt within a frame attachment hole.

Break-away RPD 204 may be made of a material having sufficient strength to receive the supplemental pulling force at from an attachment device without causing body 214 to break or undergo plastic deformation. Non-limiting examples of materials of break-away RPD 204 include metals, composite materials, carbon fiber reinforced polymers, other fiber reinforced polymers, ceramic matrix composites, and combinations thereof.

Returning to FIG. 2A, as will be described in greater detail below, body 214 includes a front-facing portion 224 that is configured to receive an impact force directed from the front of the vehicle. This will be described in greater detail with reference to FIG. 2C.

FIG. 2C illustrates break-away RPDs 202 and 204 affixed to frame 206 with an impact force, F_{I}, 234 acting on break-away RPD 204.

Consider the situation wherein a vehicle, that has frame 206 with break-away RPDs 202 and 204 being affixed to frame 206, is off-roading. In some instances, the vehicle may drive over large rocks, logs, or other obstacles, such that the obstacle impacts front-facing portion 224 of break-away RPD 204.

F_{I} 234 at front-facing portion 224 will be transferred to frame 206 of the vehicle. In particular,

As shown in the figure, when Fr 234 is applied to break-away RPD 204 by an obstacle impact, F_{I} 234 is transferred to bolt 208 as shown but impact force 236, to bolt 210 as shown by impact force 238, and to bolt 212 as shown by impact force 240. In short, the total of F_{I} 234 is distributed between bolts 208, 210, and 212, such that F_{I} 234 equals the sum of impact force 236, impact force 238, and impact force 240. As will be known to those of skill in the art, the distribution of F_{I} 234 between impact force 236, impact force 238, and impact force 240 will be dependent upon the shape of break-away RPD 204 and the location of each of bolts 208, 210, and 212, which is outside the scope of this discussion, and will not therefore be discussed in detail.

In any event, F_{I} 234 is transferred to bolts 208, 210, and 212, which in turn transfers an impact force, equal to F_{I} 234, to frame 206. The impact force transferred to frame 206 has an impact force component 242 along the axis into frame 206 and an impact force component 244 down along frame 206.

Frame 206 is designed such that if frame 206 itself receives an impact force from the front that is sufficiently large, such as in the case of a front-end collision, frame 206 will deform in a predetermined fashion so as to minimize trauma to the occupants of vehicle and minimized damage to vehicle. However, in such an instance, if F_{I} 234 is additionally transferred to frame 206, then frame will not deform in the predetermined fashion, which may not minimize trauma to the occupants of vehicle or minimized damage to vehicle, in a manner similar to the after-market RPDs discussed above with reference to FIGS. 1A-B.

In accordance with aspects of the present disclosure, a break-away RPD is able to partially break away from the frame of a vehicle when F_{I} on the break-away RPD reaches a predetermined threshold, F_{TH}. In this manner, if F_{I}≤F_{TH}, for example in situations where the driver of the vehicle is off roading, and the break-away RPD brushes against a rock, log or other obstacle, and Fr is relatively small, then the break-away RPD remains in a position for example as discussed above with reference to FIG. 2C.

For example, consider the situation wherein a vehicle, that has frame 206 with break-away RPDs 202 and 204 being affixed to frame 206, is off-roading. In some instances, the vehicle may drive over large rocks, logs, or other obstacle, such that the obstacle impacts front-facing portion 224 of break-away RPD 204.

The driver of the vehicle would not want break-away RPD 204 to partially break-away from frame 206. In accordance with aspects of the present disclosure, as mentioned above, break-away RPD 204 is designed so as to not partially break-away from frame 206 until F_{I} reaches F_{TH}.

If F_{I}>F_{TH}, for example in situations where the vehicle is involved in a front-end collision, then the break-away RPD in accordance with aspects of the present disclosure partially breaks away from the frame to prevent a large F_{I} from transferring through the break-away RPD and into the frame so as to alter the predesigned deformation of the frame. This will be described in greater detail with reference to FIG. 2D.

FIG. 2D illustrates break-away RPDs 202 and 204 affixed to frame 206 with an impact force 248 acting on break-away RPD 204, and break-away RPD 204 partially breaks away.

As shown in the figure, F_{I} 246 and F_{I} 248 represent very large impact forces, for example resulting from a front-end collision with the vehicle of frame 206. F_{I} 246 impacts a front portion 250 of frame 206, whereas F_{I} 248 impacts front-facing portion 224 of break-away RPD 204.

For purposes of discussion, let F_{I} 248 be greater than F_{TH}. As such, when F_{I} 248 encounters front-facing portion 224 of break-away RBD 204, body 214 of break-away RBD 204 rotates about bolt 208 such that bolt 210 slides out of break-away slot 218 and bolt 212 slides out of break-away slot 220.

FIG. 2E illustrates break-away RPDs 202 and 204 affixed to frame 206 as shown in FIG. 2F, but after break-away RPD 204 breaks away.

As shown in the figure, there is no longer an F_{I} impacting front-facing portion 224 of break-away RPD 204, because break-away RBD 204 has rotated about bolt 208. Accordingly, front portion 250 of frame 206 absorbs the remaining F_{I} 252, wherein F_{I} 252 equals the sum of F_{I} 246 and F_{I} 248 as shown in FIG. 2D, minus the portion of F_{I} 248 that was absorbed by front-facing portion 224 of break-away RBD 204 so as to rotate break-away RBD 204 about bolt 208 such that bolt 210 escapes break-away slot 218 and such that bolt 212 escapes break-away slot 220.

In this manner, very little force is transferred through break-away RBD 204 to frame 206 and the majority of F_{I} 252 is transferred directly into frame 206 through front portion 250 as F_{I} 254. Accordingly, if frame 206 deforms from F_{I} 254, then frame 206 will likely deform in the predetermined manner for which frame 206 was designed as a result of a front-end impact.

A user may mount a break-away RBD 204 in accordance with aspects of the present disclosure. For example, the user may insert a fixing element into the frame attachment hole of the body of the break-away RBD, wherein the body of the break-away RBD includes a recovery attachment device space, the frame attachment hole, and a break-away slot to attach the body of the break-away RBD to the vehicle frame and to enable rotation of the body about the first fixing element. The user may additionally insert another fixing element into the break-away slot to further affix the body of the break-away RBD to the vehicle frame and to enable the body to rotate away from the second fixing element.

F_{TH} generally includes two components, the sum of the force components resulting from the individual shapes of the respective break-away slots interacting with their respective bolts disposed therein, F_{SLOT}, and the sum of the force components resulting from the clamping of the respective bolts against the break-away RBD, F_{CLAMP}.

As will be discussed in greater detail below, F_{SLOT}, for each break-away slot is based on the interaction of the sides of that break-away slot and the respective bolt that is disposed therein, when the break-away RBD rotates about the bolt within the frame attachment hole.

F_{CLAMP}, on the other hand, is the tensile force in the stretched bolt. As the bolt is tightened, it stretches and develops a tensile force along its length. This tensile force in the bolt creates a compressive force between the bolt head and nut (or tapped hole in the frame), clamping the break-away RBD to the frame. F_{CLAMP} creates friction between the frame and the break-away RBD, resisting any shear forces trying to slide the break-away RBD relative to the frame. For the break-away RBD to remain clamped, F_{CLAMP} from the bolt tension must exceed the external forces trying to shear or separate the frame from the break-away RBD. The amount of F_{CLAMP} depends on factors like the bolt size, material strength, and tightening torque applied, which is known to those of skill in the art, is outside the scope of the present disclosure, and will therefore not be further described.

Consider, for purposes of discussion only, that a user mounts break-away RBD 204 to frame 206. In some embodiments, the user may insert bolt 208 into frame attachment hole 216 of body 214 of break-away RBD 204. The user may additionally insert bolt 210 into break-away slot 218 to further affix body 214 of break-away RBD 204 to frame 206 and to enable body 214 to rotate about bolt 208 and away from bolt 210. Further, the user may additionally insert bolt 212 into break-away slot 220 to further affix body 214 of break-away RBD 204 to frame 206 and to enable body 214 to rotate about bolt 208 and away from bolt 212.

In this example, F_{CLAMP} would be the sum of: the clamping force of bolt 208 being tightened against body 214, F_{CLAMP208}, thus clamping body 214 to frame 206; the clamping force of bolt 210 being tightened against body 214, F_{CLAMP210}, thus clamping body 214 to frame 206; and the clamping force of bolt 212 being tightened against body 214, F_{CLAMP212}, thus clamping body 214 to frame 206.

Clearly, different users may apply different amounts of torque to each of bolts 208, 210, and 212, when mounting break-away RBD 204, which would correspondingly result in different values for F_{CLAMP208}, F_{CLAMP210}, and F_{CLAMP212}. However, for purposes of discussion, suppose that a manufacturer of break-away RBD 204 includes mounting instructions that provide a limit to the amount of torque to be applied to each of bolts 208, 210, and 212, such that the ultimate sum of the clamping forces will have a maximum limit, F_{CLAMP-MAX}.

With this in mind, break-away RBD 204 may be designed with a predetermined F_{CLAMP-MAX}. As such, the maximum F_{TH} will be the sum of F_{SLOT} of each break-away slot and the sum of F_{CLAMP-MAX} of each break-away slot.

F_{SLOT} for each break-away slot may be determined based on the design of each break-away slot. This will be described in greater detail with reference to FIGS. 3B-4.

FIG. 3B illustrates the magnified side view of break-away RPD 204 with relative angles of slot faces. The angles of each slot face may be designed so as to provide a predetermined threshold value break-away force, F_{BA}, which retains break-away RPD 204 in a position as indicated above with reference to FIG. 2C.

As shown in FIG. 3B, in break-away slot 218, slot face 302 is flat and is positioned at an angle φ measured from 0° (e.g., flat to the ground), and slot face 304 is flat and is positioned at an angle θ measured from 0°. Further, in break-away slot 220, slot face 310 is flat and is positioned at an angle δ measured from 0°, and slot face 312 is flat and is positioned at an angle φ measured from 0°.

In some embodiments, angle φ of slot face 302 is equal to angle θ of slot face 304. In some embodiments, angle φ of slot face 302 is not equal to angle θ of slot face 304.

In some embodiments, angle δ of slot face 310 is equal to angle φ of slot face 312. In some embodiments, angle δ of slot face 310 is not equal to angle ω of slot face 312.

In some embodiments, angle φ of slot face 302 is equal to angle δ of slot face 310. In some embodiments, angle φ of slot face 302 is not equal to angle δ of slot face 310.

In some embodiments, angle θ of slot face 304 is equal to angle ω of slot face 312. In some embodiments, angle θ of slot face 304 is not equal to angle ω of slot face 312.

In some embodiments, angle φ of slot face 302 is equal to angle ω of slot face 312. In some embodiments, angle φ of slot face 302 is not equal to angle ω of slot face 312.

In some embodiments, angle θ of slot face 304 is equal to angle δ of slot face 310. In some embodiments, angle θ of slot face 304 is not equal to angle δ of slot face 310.

Each of angles θ, φ, ω, and δ may be determined to provide an overall resistant force against the rotation of body 214 about frame attachment hole 216, wherein bolt 210 interacts against at least one of slot face 302 and slot face 304 and bolt 212 interacts with slot face 310 and slot face 312. This will be described in greater detail with reference to FIG. 3C.

FIG. 3C illustrates the magnified side view of break-away RPD 204 with rotation paths about frame attachment hole 216.

As shown in the figure, when break-away RPD 204 rotates around frame attachment hole 216, bolt 210 that rests against receiving slot end 306 of break-away slot 218 will rotate in a circular path about frame attached hole 216 indicated by dashed circular track 326. In this example, the circular path has a radius R₁, which is the distance from the center of frame attachment hole 216 and the center of bolt 210 as it rests against receiving slot end 306.

Similarly, when break-away RPD 204 rotates around frame attachment hole 216, bolt 212 that rests against receiving slot end 314 of break-away slot 220 will rotate in a circular path about frame attached hole 216 indicated by dashed circular track 328. In this example, the circular path has a radius R₂, which is the distance from the center of frame attachment hole 216 and the center of bolt 212 as it rests against receiving slot end 314.

Therefore, referring to FIGS. 3B-C, by designing at least one of φ of slot face 302 and θ of slot face 304 of break-away slot 218, a resistance force, F_{R1}, may be predetermined that resists rotation of body 214 such that bolt 210 will slide through break-away slot 218 and out slot opening 308 to permit break-away RPD 204 to break away from bolt 210.

Similarly, by designing at least one of 8 of slot face 310 and @ of slot face 312 of break-away slot 220, a resistance force, F_{R2}, may be predetermined that resists rotation of body 214 such that bolt 212 will slide through break-away slot 220 and out slot opening 316 to permit break-away RPD 204 to break away from bolt 212.

Accordingly, the total resistance force is the sum of F_{R1} corresponding to bolt 210 interacting with at least one of slot face 302 and slot face 304 and F_{R2} corresponding to bolt 212 interacting with at least one of slot face 310 and slot face 312, is the predetermined threshold value break-away force, F_{BA}, which retains break-away RPD 204 in a position as indicated above with reference to FIG. 2C.

In the non-limiting example embodiments discussed above with reference to FIGS. 3A-C, the slot faces of the break-away slots are linear. However, in some embodiments, at least one slot face of a break-away slot is non-linear. This will be described in greater detail with reference to FIG. 4.

FIG. 4 illustrates a front-side oblique view of break-away slots of another example break-away RPD in accordance with aspects of the present disclosure.

As shown in the figure, the entire body of the break-away RPD is not shown. On the contrary, the figure illustrates a curved break-away slot 402, a curved break-away slot 404, and a frame attachment hole 406.

Curved break-away slot 402 includes a curved slot face 408, a curved slot face 410, and a receiving slot end 412, wherein curved slot face 408 and curved slot face 410 form a curved path 414.

Curved break-away slot 404 includes a curved slot face 416, a curved slot face 418, and a receiving slot end 420, wherein curved slot face 416 and curved slot face 418 form a curved path 422.

When the break-away RPD rotates around frame attachment hole 406, bolt 210 that rests against receiving slot end 412 of curved break-away slot 402 will rotate in along curved path 414 about frame attached hole 406. It should be noted that curved path 414 has a smaller radius of curvature as compared to the circular path about frame attached hole 406 indicated by dashed circular track 326, which has radius R₁, and which is the distance from the center of frame attachment hole 406 and the center of bolt 210 as it rests against receiving slot end 412 in a manner similar to that discussed above with reference to FIG. 3C. Because curve path 414 has a smaller radius of curvature as compared to the circular path indicated by dashed circular track 326, when bolt 210 contacts curved slot face 408 at the deviation of curved path 414 from dashed circular track 326, bolt 210 is exposed to a resistance force, F_{R3}, 424 at curved slot face 408. Further, bolt 210 will continue to be exposed to F_{R3} 424 until the break-away RPD rotates sufficiently such that bolt 210 escapes curved break-away slot 402.

Similarly, when the break-away RPD rotates around frame attachment hole 406, bolt 212 that rests against receiving slot end 420 of curved break-away slot 402 will rotate in along curved path 422 about frame attached hole 406. It should be noted that curved path 422 differs from the circular path about frame attached hole 406 indicated by dashed circular track 328, which has radius R₂, and which is the distance from the center of frame attachment hole 406 and the center of bolt 212 as it rests against receiving slot end 420 in a manner similar to that discussed above with reference to FIG. 3C. Because curve path 422 has a larger radius of curvature as compared to the circular path indicated by dashed circular track 328, when bolt 212 contacts curved slot face 418 at the deviation of curved path 422 from dashed circular track 328, bolt 212 is exposed to a resistance force, F_{R4}, 426 at curved slot face 418. Further, bolt 212 will continue to be exposed to F_{R4} 426 until the break-away RPD rotates sufficiently such that bolt 212 escapes curved break-away slot 404.

Accordingly, the total resistance force is the sum of F_{R3} corresponding to bolt 210 interacting with curved slot face 408 and F_{R4} corresponding to bolt 212 interacting with curved slot face 418, is the predetermined threshold value break-away force, F_{BA}, which retains the break-away RPD in a position in a manner similar to that as indicated above with reference to FIG. 2C.

In some embodiments, the radius of curvature of curved break-away slot 402 is the same radius of curvature of curved break-away slot 404.

In some embodiments, the radius of curvature of curved break-away slot 402 is the different from the radius of curvature of curved break-away slot 404.

In some embodiments, one break-away slot has linear slot faces in a manner similar to that discussed above with reference to FIG. 3B, whereas another break-way slot has curved slot faces in a manner similar to that discussed above with reference to FIG. 4.

In accordance with aspects of the present disclosure, a break-away RBD includes at least one break-away slot designed so as to establish the predetermined threshold value break-away force, F_{BA}, which retains the break-away RPD in a position in a manner similar to that as indicated above with reference to FIG. 2C.

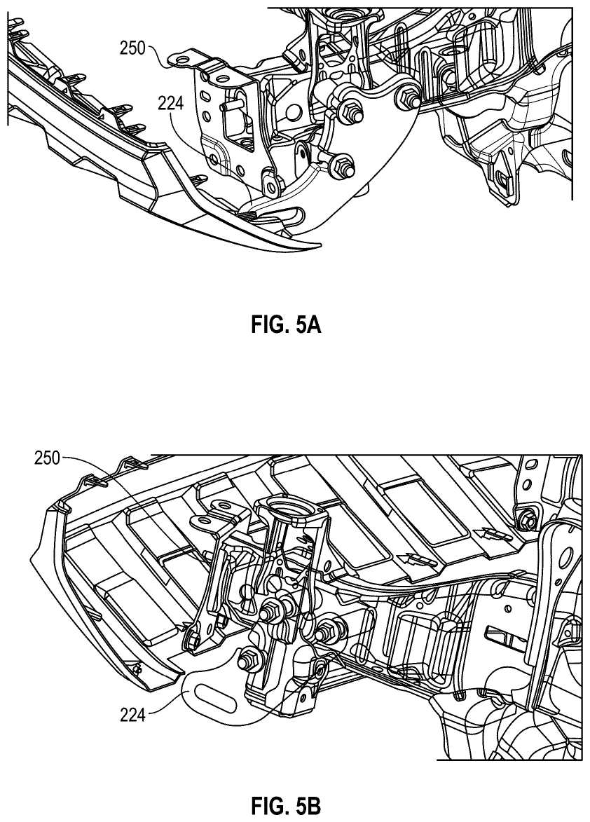

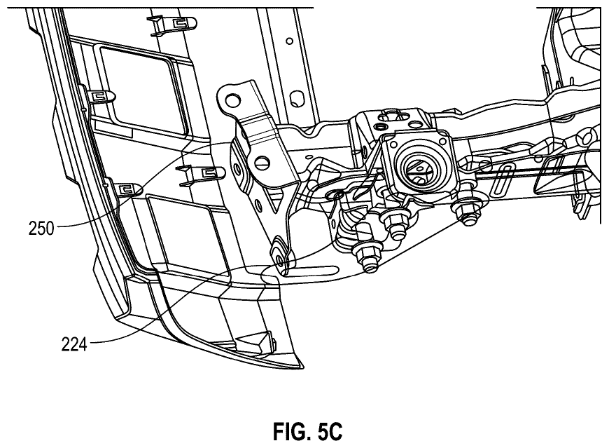

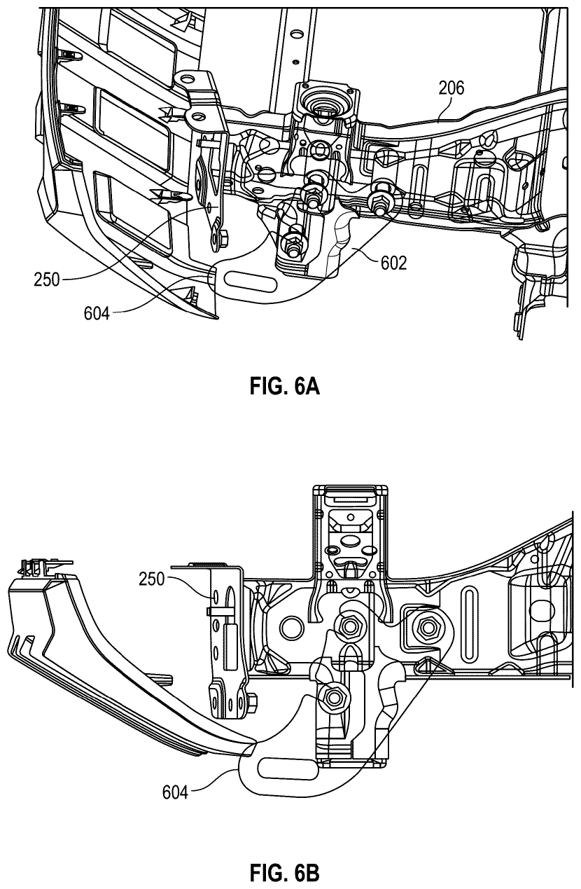

It should be noted that a front-facing portion of a break-away RPD in accordance with aspects of the present disclosure may be configured to be disposed behind a front portion of the frame, to be disposed even with the front portion of the frame, and to be in front of the front portion of the frame. This will be described in greater detail with reference to FIGS. 5A-6B.

FIG. 5A illustrates a front-side oblique view of break-away RPD 204 mounted to frame 206. FIG. 5B illustrates a rear-side oblique view of break-away RPD 204 mounted to frame 206. FIG. 5B illustrates a top-side oblique view of break-away RBD 204 mounted to frame 206.

As shown in the figures, front-facing portion 224 extends beyond front portion 250 of frame 206. Accordingly, in the event of a front-on collision, front-facing portion 224 will be impacted by the impact force from the collision before front portion 250 of frame 206.

FIG. 6A illustrates a top-side oblique view of another example break-away RPD 602 mounted to frame 206 of a vehicle in accordance with aspects of the present disclosure. FIG. 6B illustrates a side view of break-away RPD 602 mounted to frame 206.

As shown in the figures, a front-facing portion 604 does not extend beyond front portion 250 of frame 206. Accordingly, in the event of a front-on collision, front portion 250 of frame 206 will be impacted by the impact force from the collision before front-facing portion 604.

Conventional RPDs are rigidly attached to the frame of a vehicle. As such, in the event of a collision, the impact force upon the rigidly attached RPDs are transferred to the frame of the vehicle. In the event that the frame of the vehicle was designed to deform from an impact in a predetermined manner, the contribution of the impact from the attached RPD will likely result in an unpredicted deformation of the frame.

In accordance with aspects of the present disclosure, a break-away RPD includes a break-away feature, wherein upon receiving an impact force above a predetermined threshold, the break-away RPD partially breaks away from the frame in a manner that prevents the impact force on the break-away RPD from being transferred to the frame. In this manner, in the event of a collision, the frame of the vehicle will deform from an impact in the predetermined manner as designed.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A break-away recovery point device for use with a vehicle frame, said break-away recovery point device comprising:
a body having a recovery attachment device space, a frame attachment hole, and a break-away slot,
wherein said recovery attachment device space is configured to receive a recovery attachment device that provides a supplemental pulling force,
wherein said frame attachment hole is configured to receive a first fixing element to affix said body to the vehicle frame and to enable rotation of said body about the first fixing element, and
wherein said break-away slot is configured to receive a second fixing element to affix said body to the vehicle frame and to enable said body to rotate away from the second fixing element.

2. The break-away recovery point device of claim 1,
wherein said break-away slot comprises a first slot face, a second slot face, and a receiving slot end, and
wherein said receiving slot end is configured to receive the second fixing element such that the supplemental pulling force will be distributed between a first contact of said frame attachment hole with the first fixing element and said receiving slot end and the second fixing element.

3. The break-away recovery point device of claim 2, wherein said first slot face is parallel with said second slot face.

4. The break-away recovery point device of claim 2, wherein said first slot face is linear.

5. The break-away recovery point device of claim 2, wherein said first slot face is non-linear.

6. The break-away recovery point device of claim 5, wherein said first slot face comprises an arc that is unaligned with a circular arc of rotation about said frame attachment hole.

7. The break-away recovery point device of claim 6, wherein said arc has a curvature that is greater than a curvature of the circular arc of rotation about said frame attachment hole.

8. The break-away recovery point device of claim 6, wherein said arc has a curvature that is less than a curvature of the circular arc of rotation about said frame attachment hole.

9. The break-away recovery point device of claim 2, wherein the body further has a second break-away slot configured to receive a third fixing element to affix said body to the vehicle frame and to enable said body to rotate away from the third fixing element.

10. The break-away recovery point device of claim 9,
wherein said second break-away slot comprises a third slot face, a fourth slot face, and a second receiving slot end, and
wherein said second receiving slot end is configured to receive the third fixing element such that the supplemental pulling force will be distributed between a first contact of said frame attachment hole with the first fixing element, said receiving slot end and the second fixing element, and said second receiving slot end and the third fixing element.

11. The break-away recovery point device of claim 10, wherein said third slot face is parallel with said second slot face.

12. The break-away recovery point device of claim 10, wherein said third slot face is linear.

13. The break-away recovery point device of claim 10, wherein said third slot face is non-linear.

14. The break-away recovery point device of claim 13, wherein said third slot face comprises an arc that is unaligned with a circular arc of rotation about said frame attachment hole.

15. The break-away recovery point device of claim 14, wherein said arc has a curvature that is greater than a curvature of the circular arc of rotation about said frame attachment hole.

16. The break-away recovery point device of claim 14, wherein said arc has a curvature that is less than a curvature of the circular arc of rotation about said frame attachment hole.

17. A vehicle comprising:
a vehicle frame; and
a break-away recovery point device comprising a body having a recovery attachment device space, a frame attachment hole, and a break-away slot; a first fixing element; and a second fixing element,
wherein said recovery attachment device space is configured to receive a recovery attachment device that provides a supplemental pulling force,
wherein said frame attachment hole is configured to receive said first fixing element to affix said body to said vehicle frame and to enable rotation of said body about said first fixing element, and
wherein said break-away slot is configured to receive said second fixing element to affix said body to said vehicle frame and to enable said body to rotate away from said second fixing element.

18. The vehicle of claim 17,
wherein said break-away slot comprises a first slot face, a second slot face, and a receiving slot end, and
wherein said receiving slot end is configured to receive the second fixing element such that the supplemental pulling force will be distributed between a first contact of said frame attachment hole with said first fixing element and said receiving slot end and said second fixing element.

19. A method of mounting a break-away recovery point device to a vehicle frame, said method comprising:
inserting a first fixing element into a frame attachment hole of a body having a recovery attachment device space, the frame attachment hole, and a break-away slot to attach the body to the vehicle frame and to enable rotation of the body about the first fixing element; and
inserting a second fixing element into the break-away slot further to affix the body to the vehicle frame and to enable said body to rotate away from the second fixing element,
wherein the recovery attachment device space is configured to receive a recovery attachment device that is able to provide a supplemental pulling force.

20. The method of claim 19,
wherein the break-away slot comprises a first slot face, a second slot face, and a receiving slot end, and
wherein the receiving slot end is configured to receive the second fixing element such that the supplemental pulling force will be distributed between a first contact of the frame attachment hole with the first fixing element and the receiving slot end and the second fixing element.
